(19) United States
(12) Patent Application Publication
(10) Pub. No.: US 2003/0027556 A1
(43) Pub. Date: Feb. 6, 2003

(54) Program distributing system and method and program reproducing apparatus and method

(76) Inventor: Hideaki Kobayashi, Kobe-shi (JP)

Correspondence Address: RATNERPRESTIA, P O BOX 980, VALLEY FORGE, PA, 19482-0980, US

(21) Appl. No.: 10/176,568

(22) Filed: Jun. 21, 2002

(30) Foreign Application Priority Data
Aug. 3, 2001 (JP) 2001-236832

(51) Int. Cl. H04M 3/42; H04M 3/00

(52) U.S. Cl. 455/414; 455/418

(57) ABSTRACT

A program distributing system, has

a first apparatus which comprises broadcast means which broadcasts a particular program which provides a privilege; and

a second apparatus which comprises:

check means which executes a check to find whether the particular program is watched or not from a channel on which and a time zone in which a program is being currently received;

effective term calculation means which calculates the effective term for the privilege from the viewing time of the particular program when it is determined as a result of the check that the particular program is watched;

ID calculation means which calculates an ID based on the viewing time or the effective term; and

display means which causes at least information regarding the privilege to be displayed.

### BACKGROUND OF THE INVENTION

1. Field of the Invention

The present invention relates to a program distributing system or the like which distributes a privilege-added particular program such as advertisement information offering a prize for instance.

2. Related Art of the Invention

Broadcasting and the Internet have already established a business that information providers, such as a broadcasting company, which provide information through broadcasting, the Internet or the like, airing or displaying advertisement information to viewers, collect advertisement fees from advertisers which provide advertisements.

Further, some of advertisement information offer prizes in an attempt to attract viewers' interests, and a viewer, watching the advertisement information and applying through application means, such as postal mails and e-mails, to particular destinations described in the advertisement information, may get the prize articles.

Since such advertisement information offering prizes per se is valuable as advertisements and achieves large advertising effects, it is expected that such advertisement information will be used more frequently.

However, advertisement information is uniform broadcasting and presentation that show all viewers contents created or offered by advertisers in accordance with the deadlines instructed by the advertisers.

A prize-offered campaign using such advertisement information may lead to the following inconveniences.

Now, it is assumed that advertisement information is a TV commercial and a provider of the advertisement information is a TV station. The TV commercial is linked with a prize-offered campaign, and a content of the TV commercial is that a viewer applying by a predetermined deadline can get a prize. With respect to the TV commercial, an airing term, the airing start timing, the airing end timing and the deadline for applying the prize-offered campaign are determined in advance.

As shown in FIG. 6, the commercial offering such a prize is provided as highly fresh information to a viewer A who watches this commercial immediately after the airing start timing of the broadcast of this commercial, since there is enough time for the viewer A by the deadline set for the prize-offered campaign. This also means that the added value of this commercial is maintained for a long period.

On the other hand, to a viewer B who watches this commercial for the first time after a considerable number of days since the start of before the broadcast of this commercial and therefore right the end of the broadcast, there is not any time left by the deadline set for the prize-offered campaign. Hence, the freshness of the information has been lowered as viewed from this person B, and the commercial does not have almost any added value.

### SUMMARY OF THE INVENTION

The present invention has been made in view of these problems described above. Accordingly, an object of the present invention is to provide a program distributing system or the like with which it is possible to maintain the added value of a program equally to the individual viewers who watch the same program at different hours.

The 1st invention of the present invention is a program distributing system, comprising:

a first apparatus which comprises broadcast means which broadcasts a particular program which provides a privilege; and

a second apparatus which comprises:

check means which executes a check to find whether said particular program is watched or not from a channel on which and a time zone in which a program is being currently received;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 1st invention of the present invention is a program distributing system, comprising:

a first apparatus which comprises broadcast means which broadcasts a particular program which provides a privilege; and

a second apparatus which comprises:

check means which executes a check to find whether said particular program is watched or not by detecting reproduction of said program after storage of said program in a recording medium;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 3rd invention of the present invention is the program distributing system of 1st or 2nd inventions, wherein said ID is obtained by executing predetermined computation on said ID and calculating back said viewing time or said effective term.

The 4th invention of the present invention is a program reproducing apparatus, comprising:

check means which executes a check to find whether a particular program which provides a privilege is watched or not by detecting playback of a recording medium in which said particular program is recorded;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 5th invention of the present invention is the program reproducing apparatus of 4th invention, wherein said ID is obtained by executing predetermined computation on said ID and calculating back said viewing time or said effective term.

The 6th invention of the present invention is a first apparatus which comprises broadcast means which broadcasts a particular program which is received by a second apparatus and provides a privilege,

wherein said second apparatus comprises:

check means which executes a check to find whether said particular program is watched or not from a channel on which and a time zone in which a program is being currently received;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 7th invention of the present invention is a first apparatus which comprises broadcast means which broadcasts a particular program which is received by a second apparatus and provides a privilege, wherein said second apparatus comprises:

check means which executes a check to find whether said particular program is watched or not by detecting reproduction of said program after storage of said program in a recording medium;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 8th invention of the present invention is the first apparatus of 6th or 7th inventions, wherein said ID is obtained by executing predetermined computation on said ID and calculating back said viewing time or said effective term.

The 9th invention of the present invention is the first apparatus of 6th or 7th inventions, wherein said broadcast means also broadcasts information regarding said privilege and information regarding a channel on which and an hour at which said particular program which provides said privilege is broadcasted.

The 10th invention of the present invention is the first apparatus of 9th inventions, wherein broadcasting of the information regarding said privilege and the information regarding a channel on which and an hour at which said particular program which provides said privilege is broadcasted takes place before the first airdate/airtime for said particular program which provides said privilege.

The 11th invention of the present invention is the program reproducing apparatus of 4th invention, wherein said recording medium is recorded information regarding said privilege and information regarding the time at which said particular program is to be reproduced.

The 12th invention of the present invention is the program reproducing apparatus of 4th invention, wherein said display means is capable of causing said ID as well to be displayed.

The 13th invention of the present invention is a second apparatus which receives a particular program provides a privilege and which is broadcasted from a first apparatus which comprises broadcast means which broadcasts said particular program, comprising:

check means which executes a check to find whether said particular program is watched or not from a channel on which and a time zone in which a program is being currently received;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 14th invention of the present invention is a second apparatus which receives a particular program provides a privilege and which is broadcasted from a first apparatus which comprises broadcast means which broadcasts said particular program, comprising:

check means which executes a check to find whether said particular program is watched or not by detecting reproduction of said program after storage of said program in a recording medium;

effective term calculation means which calculates the effective term for said privilege from the viewing time of said particular program when it is determined as a result of said check that said particular program is watched;

ID calculation means which calculates an ID based on said viewing time or said effective term; and

display means which causes at least information regarding said privilege to be displayed.

The 15th invention of the present invention is the second apparatus of 13th or 14th inventions, wherein said ID is obtained by executing predetermined computation on said ID and calculating back said viewing time or said effective term.

The 16th invention of the present invention is the second apparatus of 13th or 14th inventions, wherein said broadcast means of said first apparatus also broadcasts information regarding said privilege and information regarding a channel in which and an hour at which said particular program which provides said privilege is broadcasted.

The 17th invention of the present invention is the second apparatus of 16th invention, wherein broadcasting of the information regarding said privilege and the information regarding the channel on which and the time at which said particular program which provides said privilege is broadcasted takes place before the first airdate/airtime of said particular program which provides said privilege.

The 18th invention of the present invention is the second apparatus of 13th or 14th inventions, wherein said display means is capable of causing said ID as well to be displayed.

The 19th invention of the present invention is a program distributing method, comprising:

a broadcast step of broadcasting a particular program which provides a privilege;

a check step of checking whether said particular program is watched or not from a channel on which and a time zone in which a program is being currently received;

an effective term calculation step of calculating the effective term for said privilege from the viewing time of said particular program when it is determined as a result of said check that said particular program is watched;

an ID calculation step of calculating an ID based on said viewing time or said effective term; and

a display step of causing at least information regarding said privilege to be displayed.

The 20th invention of the present invention is a program distributing method, comprising:

a broadcast step of broadcasting a particular program which provides a privilege;

a check step of executing a check to find whether said particular program is watched or not by detecting reproduction of said program after storage of said program in a recording medium;

an effective term calculation step of calculating the effective term for said privilege from the viewing time of said particular program when it is determined as a result of said check that said particular program is watched;

an ID calculation step of calculating an ID based on said viewing time or said effective term; and

a display step of causing at least information regarding said privilege to be displayed.

The 21st invention of the present invention is a program reproducing method, comprising:

a check step of executing a check to find whether a particular program which provides a privilege is watched or not by detecting playback of a recording medium in which said particular program is recorded;

an effective term calculation step of calculating the effective term for said privilege from the viewing time of said particular program when it is determined as a result of said check that said particular program is watched;

an ID calculation step of calculating an ID based on said viewing time or said effective term; and

a display step of causing at least information regarding said privilege to be displayed.

The 22nd invention of the present invention is the program reproducing method of 19th or 20th inventions, wherein said ID is obtained by executing predetermined computation on said ID and calculating back said viewing time or said effective term.

The 23rd invention of the present invention is the program reproducing method of 21st invention, wherein said ID is obtained by executing predetermined computation on said ID and calculating back said viewing time or said effective term.

The 24th invention of the present invention is a program which makes a computer function as all or some of said broadcast means of said first apparatus which broadcasts a particular program which provides a privilege, and said check means of said second apparatus which executes a check to find whether said particular program is watched or not from a channel on which and a time zone in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term and said display means of said second apparatus which causes at least information regarding said privilege to be displayed of the program distributing system of 1st invention.

The 25th invention of the present invention is a program which makes a computer function as all or some of said broadcast means of said first apparatus which broadcasts a particular program which provides a privilege, and said check means of said second apparatus which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term and said display means of said second apparatus which causes at least information regarding said privilege to be displayed of the program distributing system of 2nd invention.

The 26th invention of the present invention is a program which makes a computer function as all or some of said check means which executes a check to find whether a particular program which provides a privilege is watched or not by detecting playback of a recording medium in which said particular program is recorded, said effective term calculation means of said program reproducing apparatus which calculates the effective term for said privilege from the viewing time of said particular program when it is determined as a result of said check that said particular program is watched, and said ID calculation means of said program reproducing apparatus which calculates an ID based on said viewing time or said effective term, and said display means of said second apparatus which causes at least information regarding said privilege to be displayed of the program reproducing apparatus of 4th invention.

The 27th invention of the present invention is a program which makes a computer function as all or some of said check means which executes a check to find whether said particular program is watched or not from a channel on which and a slot in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of 13th invention.

The 28th invention of the present invention is a program which makes a computer function as all or some of said check means which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of 14th invention.

The 29th invention of the present invention is a medium which can be processed on a computer and holds a program which makes a computer function as all or some of said broadcast means of said first apparatus which broadcasts a particular program which provides a privilege, and said check means of said second apparatus which executes a check to find whether said particular program is watched or not from a channel on which and a time zone in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the program distributing system of 1st invention.

The 30th invention of the present invention is a medium which can be processed on a computer and holds a program which makes a computer function as all or some of said broadcast means of said first apparatus which broadcasts a particular program which provides a privilege, and said check means of said second apparatus which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the program distributing system of 2nd invention.

The 31st invention of the present invention is a medium which can be processed on a computer and holds a program which makes a computer function as all or some of said check means which executes a check to find whether a particular program which provides a privilege is watched or not by detecting playback of a recording medium in which said particular program is recorded, said effective term calculation means of said program reproducing apparatus which calculates the effective term for said privilege from the viewing time of said particular program when it is determined as a result of said check that said particular program is watched, and said ID calculation means of said program reproducing apparatus which calculates an ID based on said viewing time or said effective term, and said display means of said second apparatus which causes at least information regarding said privilege to be displayed of the program reproducing apparatus of 4th invention.

The 32nd invention of the present invention is a medium which can be processed on a computer and holds a program which makes a computer function as all or some of said check means which executes a check to find whether said particular program is watched or not from a channel on which and a slot in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of 13th invention.

The 33rd invention of the present invention is a medium which can be processed on a computer and holds a program which makes a computer function as all or some of said check means which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of 14th invention.

Since the invention as described above makes it possible to provide a particular program, such as advertisement information, to the individual viewers in accordance with the timing at which the respective viewers watch the program, the added value of the program will not decrease due to the timing of the broadcast. A resulting profit may be received not only by a program distributing service which provides broadcasting or presentation of an advertisement but to a manufacturer of an advertisement information reproducing apparatus as well.

### BRIEF DESCRIPTION OF THE DRAWINGS

FIG. 1 is a drawing showing the structure of the program distributing system according to the first preferred embodiment of the present invention.

FIG. 2 is a drawing for describing the effect of the program distributing system according to the first preferred embodiment of the present invention.

FIG. 3 is a drawing other example of the structure of the program distributing system according to the first preferred embodiment of the present invention.

FIG. 4 is a drawing showing the structure of the program distributing system according to the second preferred embodiment of the present invention.

FIG. 5 is a drawing showing the structure of the program distributing system according to the third preferred embodiment of the present invention.

FIG. 6 is a drawing for describing the advertising effect of a commercial according to a conventional technique.

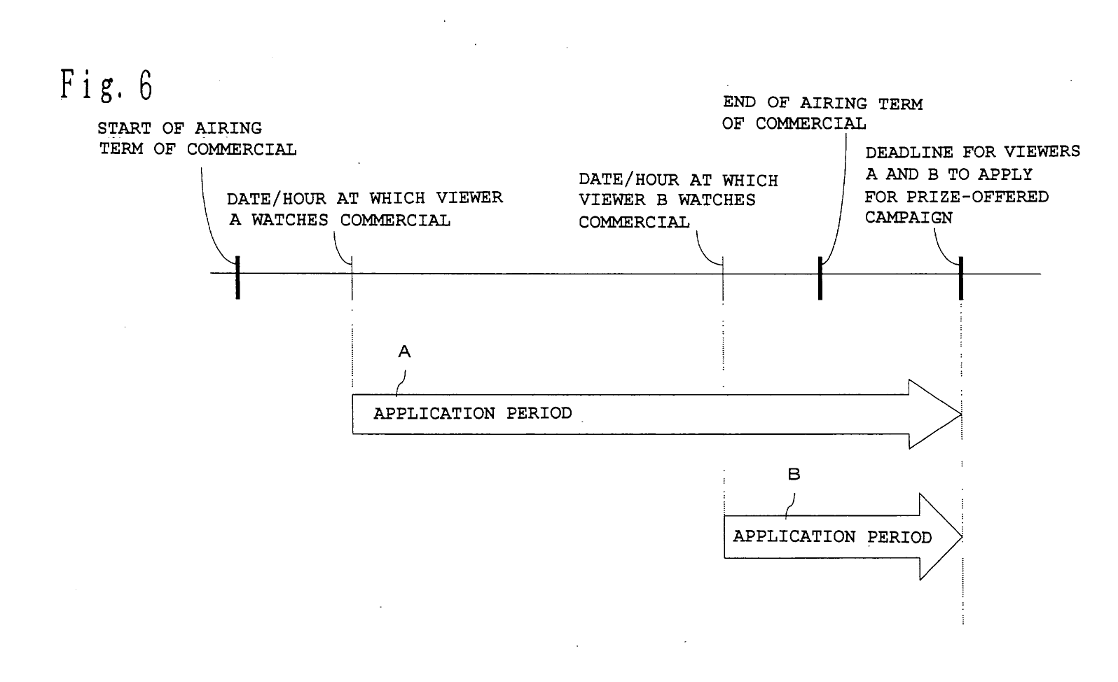

FIG. 7 is a drawing showing the structure of the program distributing system according to the fourth preferred embodiment of the present invention.

FIG. 8 is a drawing showing the structure of the program reproducing apparatus according to the fifth preferred embodiment of the present invention.

### DESCRIPTION OF SYMBOLS

100 program distributing system

110 broadcast station

111 broadcast means

112 inverse operation means

120 television set

121 receiver unit

122 display unit

130 privilege information processing means

131 check means

132 effective term calculation means

133 ID calculation means

134 memory means

135 display means

### PREFERRED EMBODIMENTS OF THE INVENTION

Preferred embodiments of the present invention will now be described with reference to associated drawings.

(First Preferred Embodiment)

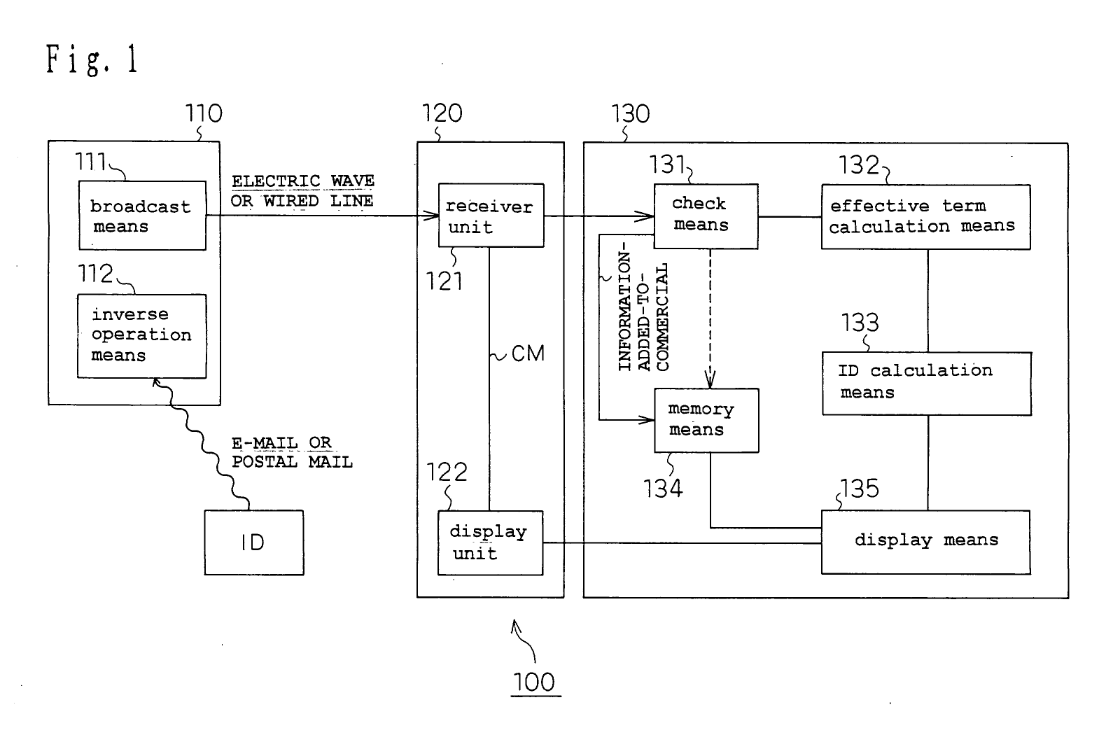

FIG. 1 is a structure diagram of a program distributing system according to a first preferred embodiment of the present invention. In FIG. 1, a program distributing system 100 comprises a broadcast station 110 which broadcasts programs and other information, a television set 120 to which a signal is transmitted from the broadcast station 110 via an electric wave, a wired line or the like, and a privilege information processing apparatus 130 which is connected with the television set 120 and receives the signal from the broadcast station 110.

The broadcast station 110 broadcasts a program, which contains commercials and a normal content, and additional information such as character information, and comprises broadcast means 111 which broadcasts the program as a signal and inverse operation means 112 which calculates back an ID which will be described later.

Meanwhile, the television set 120 is means which receives a program broadcasted by the broadcast station 110 and makes it possible to watch the program, and comprises a receiver unit 121 which receives and processes a signal from the broadcast station and a display unit 122 which displays such that the broadcast can be watched.

The privilege information processing apparatus is means which is used as connected with the television set 120, and comprises check means 131 which, like the receiver unit 121 of the television set 120, receives a signal from the broadcast station 110 and checks the content of the signal, effective term calculation means 132 which calculates an effective term based on the result of the check executed by the check means 131, ID calculation means 133 which calculates a predetermined ID based on the effective term, memory means 134 which temporarily accumulates information-added-to-commercial other than a program received from the broadcast station 110 which will be described later, and display means 135 which allows information read from the memory means 134 to be superimposed and displayed in the display unit 122 of the television set 120.

Operations of the program distributing system according to the first preferred embodiment of the present invention having such a structure will now be described, in association with which operations of a first apparatus, a second apparatus and a program distributing method according to the present invention will be described. The description below assumes that the broadcast station 110 broadcasts a program in a ground-based analog broadcasting scheme.

First, in the broadcast station 110, the broadcast means 111 broadcasts a commercial. The commercial is linked with a prize-offered campaign which is presented by an advertiser. Applying via a postal mail or e-mail to a particular destination described in the content of the commercial, a viewer can win a prize from the advertiser. However, information itself of the prize-offered campaign is not contained in the commercial. In addition, with respect to the commercial, an airing term, the airing start timing and the airing end timing are determined in advance.

Further, according to the first preferred embodiment, the application destination for the prize-offered campaign is the broadcast station 110.

Further, before airing the commercial described above, the broadcast station 110 broadcasts the information-added-to-commercial regarding the prize-offered campaign which is linked with the commercial. This information contains the content of and an applying period for the prize-offered campaign, and information regarding the airing term, the airing start timing, the airing end timing and a channel on which the commercial is broadcasted.

As for a method of sending the information-added-to-commercial, the information may be inserted during a blanking period for a regular program broadcast (including commercials) of television broadcasting.

The airing start timing for airing the information-added-to-commercial may be until at least the first airing of the commercial. It is only necessary that when the commercial is ready to be watched on the television set 120, the privilege information processing apparatus 130 is ready to process the information-added-to-commercial. In addition, the information-added-to-commercial may be transmitted not only once but more than once by the first airing of the commercial.

On the other hand, the television set 120 first receives the information-added-to-commercial as an airwave. Of this, the information-added-to-commercial is not processed by the television set 120 but outputted to the privilege information processing apparatus 130. The privilege information processing apparatus 130, receiving the information-added-to-commercial from the television set 120, temporarily records the information-added-to-commercial in the memory means 134.

The television set 120 then receives the commercial. The received commercial processed in the receiver unit 121 is displayed in the display unit 122 and watched by a viewer while at the same time sent to the privilege information processing apparatus 130.

In the privilege information processing apparatus 130, usually, the check means 131 checks a channel on which and an hour at which the program received by the receiver unit 121 of the television set 120 is watched, by means of channel setting for the television set 120 and an internal clock not shown. The internal clock may be built within the television set 120.

Further, the check is done with reference to the information-added-to-commercial already temporarily recorded in the memory means 134. This operation is carried out while the television set 120 is operating, so that the check means 131 decides the receiving operation of the television set 120 as watching of the program by a viewer on the television set 120.

As the television set 120 receives the commercial which is associated with the information-added-to-commercial, the check means 131 refers to the information-added-to-commercial which is in the memory means 134, and confirms that the airing time zone and the channel of the commercial match with the air time and the channel of the received commercial.

Next, in response to the confirmation made by the check means 131, the effective term calculation means 132 detects the hour at which the commercial is currently being received, and calculates, as the effective term, a period which is left from the detected hour by the deadline for applying for the prize-offered campaign which is described in the information-added-to-commercial.

Next, acquiring the effective term from the effective term calculation means 132, the ID calculation means 133 calculates an ID based on the effective term. The ID is to serve as a proof to the broadcast station 110 showing the receipt of the commercial by the television set 120 at the hour above. The ID calculation means 133 may calculate the ID directly from the hour at which the commercial is received, instead of calculating based on the effective term.

Upon creation of the ID by the ID calculation means 133, the display means 135 reads out the information-added-to-commercial from the memory means 134, creates the content of the prize-offered campaign as privilege information, and outputs this information with the effective term calculated by the effective term calculation means 132 and the ID to the television set 120, as a video signal.

The television set 120, in the display unit 122, superimposes and displays the commercial received earlier by the receiver unit 121, the privilege information, the effective term and the ID outputted from the privilege information processing apparatus 130. The commercial displayed in the display unit 122 shows the content of the prize-offered campaign corresponding to the commercial together with the deadline of applying for the campaign and the ID to a viewer watching the television set 120.

Noting the prize-offered campaign displayed together with the commercial, the viewer applies for the campaign to the broadcast station 110 using such means as a postal mail and an e-mail in accordance with the outline regarding application. On this occasion, the viewer should copy the ID which is displayed in the display unit 122 of the television set 120 into application items which are to be described in a postal mail or e-mail.

Upon receipt of the campaign application from the viewer by the broadcast station 110, the inverse operation means 112 processes the ID which is described in the campaign application, whereby the time in which the viewer watched the commercial is calculated from the ID, the calculated time is checked against the airing term and the airing slot of the commercial, and whether the viewer actually watched the commercial or not is confirmed.

After the confirmation of the ID, the broadcast station 110 carries out a process regarding a prize in a conventional manner.

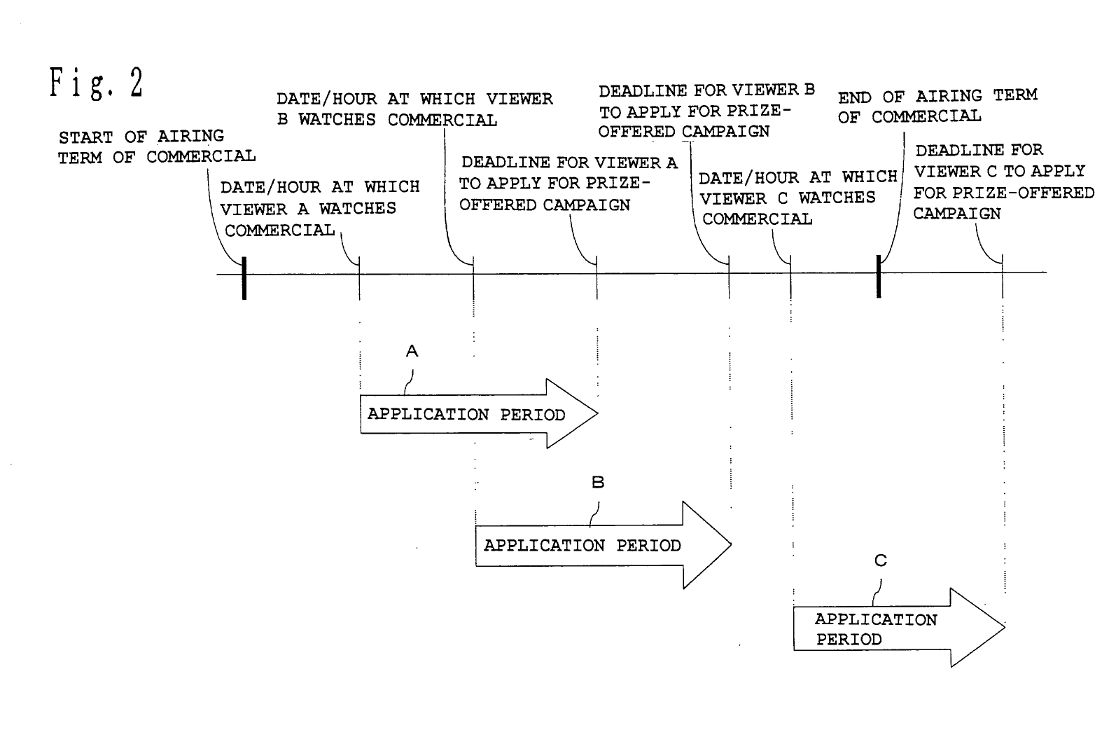

In the operations above, with respect to the prize-offered campaign corresponding to the commercial, the content, the application deadline and the like regarding the prize-offered campaign are sent separately from the commercial as the information-added-to-commercial. The information-added-to-commercial is provided to the viewer as the privilege information for the first time, when the commercial is received by the television set 120. Further, the application deadline is set only upon the receipt of the commercial by the television set 120. This will now be described with reference to FIG. 2.

As shown in FIG. 2, although the airing term, the airing start timing and the airing end timing for the commercial are determined uniformly as in a conventional manner, a certain period of time to apply for the prize-offered campaign linked with the commercial is determined starting from the time at which the viewer watches the commercial. Thus, the application deadline dates are different between different viewers, and therefore, all viewers have fair opportunities to participate in the prize-offered campaign regardless of the timing at which the viewers watch the commercial.

In other words, although viewers watch the same commercial, since the content of the privilege information which is added to the commercial is different depending on an hour at which a viewer watches the commercial, the freshness of the privilege information and hence the added value of the commercial are maintained constant.

Thus, using the program distributing system according to the first preferred embodiment, the privilege information which is added to the commercial is aired separately from the commercial and shown to a viewer as a content which is based on an hour at which the viewer watches the commercial, so that the added value of the aired program can be maintained constant regardless of the term or the timing of the broadcast.

Although the foregoing has described that according to the first preferred embodiment, to apply for the prize-offered campaign based on the privilege information which is obtained through the program distributing system 100 is to copy the ID displayed by the display means 135 in the display unit 122 of the television set 120 and to describe the ID in a postal mail or e-mail, to display the ID on the television set 120 is not desirable in light of the confidentiality of information.

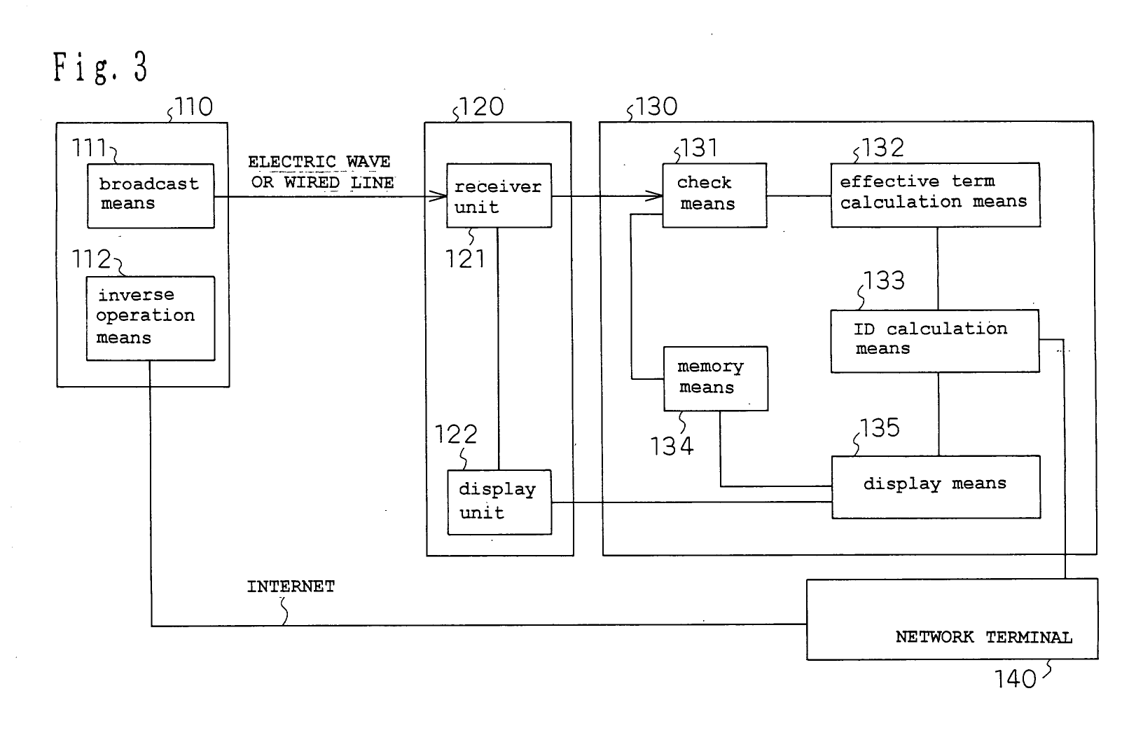

Noting this, other example of the structure of the program distributing system 100 shown in FIG. 3 uses, as means in order to apply for a campaign, a network terminal 140 which can send an e-mail to the broadcast station 110, when connected to the privilege information processing apparatus 130, via a network such as the Internet.

In this example of the structure, the network terminal 140 directly accepts entry of an ID from the ID calculation means 133 and holds the ID for the time being, and inserts the ID to an e-mail while a viewer writes the e-mail to apply for a prize-offered campaign.

Hence, it is only necessary that the display means 135 displays only the effective term calculated by the effective term calculation means 132 and the privilege information read from the memory means 134 in the display unit of the television set 120, and thus, it is possible to provide the privilege information without displaying the ID. The network terminal 140 may be a personal computer which is hooked on the Internet or a portable information terminal such as a cellular telephone. Alternatively, the privilege information processing apparatus 130 itself may have a function of connecting to a network and communicating. Further, the network is not limited to the Internet but may be other local network, such as an intranet, or a telephone line. In effect, the network only needs be separate from a transmission line over which the commercial is transmitted.

(Second Preferred Embodiment)

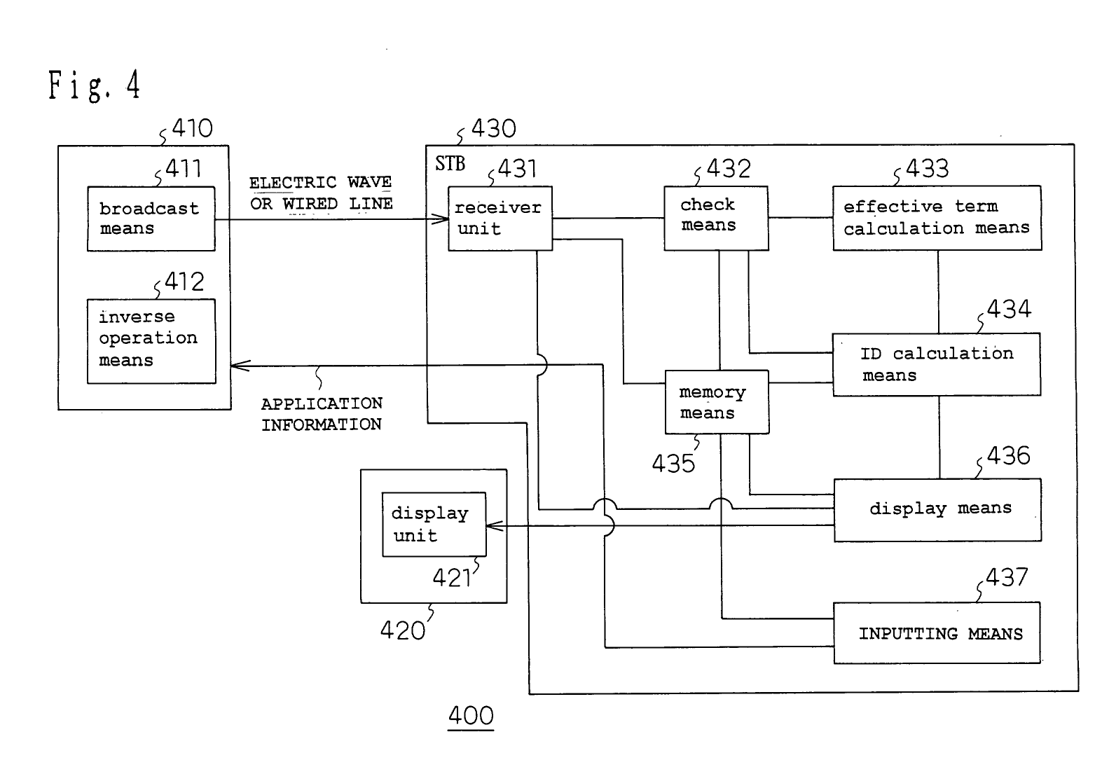

FIG. 4 is a structure diagram of a program distributing system according to a second preferred embodiment of the present invention. The program distributing system according to the second preferred embodiment allows that a program accompanying a privilege is broadcasted in digital broadcasting and a response is obtained to the broadcast, and achieves a similar effect to that according to the first preferred embodiment.

In FIG. 4, a program distributing system 400 comprises a digital broadcast station 410 which broadcasts programs and other information, a set top box (hereinafter referred to as an “STB”) 430 to which a signal from the digital broadcast station 410 is transmitted via an electric wave, a wired line or the like, and a television set 420 which displays an AV signal which is outputted from the STB 430.

The digital broadcast station 410 broadcasts a program, which contains commercials and a normal content, and additional information such as character information, in a multiplexed digital broadcasting format, and comprises broadcast means 411 which broadcasts the program as a signal and inverse operation means 412 which calculates back an ID which will be described later.

Meanwhile, the television set 420 is means which displays an AV signal representing a broadcast which is outputted from the STB 430, and comprises a display unit 421 which displays such that the broadcast can be watched.

The STB 430 is means which receives a digital broadcast and causes the television set 420 to display the broadcast, and comprises a receiver unit 431 which receives a signal from the digital broadcast station 410, check means 432 which checks the content of the broadcast received at the receiver unit 431, effective term calculation means 433 which calculates an effective term based on the result of the check executed by the check means 432, ID calculation means 434 which calculates a predetermined ID based on the effective term, memory means 435 which temporarily accumulates information-added-to-commercial other than a program received from the broadcast station 410 which will be described later, display means 436 which allows information read from the memory means 435 to be superimposed and displayed in the display unit 421 of the television set 420, and inputting means 437 which is disposed for bi-directional communication with the broadcast station 410 and is capable of accepting inputs from viewers.

Operations of the program distributing system according to the second preferred embodiment of the present invention having such a structure will now be described, in association with which operations of the first apparatus, the second apparatus and the program distributing method according to the present invention will be described.

First, in the digital broadcast station 410, the broadcast means 411 broadcasts a commercial. The commercial is linked with a prize-offered campaign which is presented by an advertiser. Applying to an application destination described in the content of the commercial using a communication function of the STB 430, a viewer can win a prize from the advertiser. However, information itself of the prize-offered campaign is not contained in the commercial. In addition, with respect to the commercial, an airing term, the airing start timing and the airing end timing are determined in advance. In the second preferred embodiment, the application destination for the prize-offered campaign is the digital broadcast station 410.

Further, before airing the commercial described above, the digital broadcast station 410 broadcasts the information-added-to-commercial regarding the prize-offered campaign which is linked with the commercial. This information contains the content of and an applying period for the prize-offered campaign, and information regarding the airing term, the airing start timing, the airing end timing and a channel on which the commercial is broadcasted.

As for a method of sending the information-added-to-commercial, a multiplexed stream, i.e., a program stream of a regular program broadcast in television broadcasting to which a stream of the information-added-to-commercial is inserted, maybe sent. The airing start timing for airing the information-added-to-commercial maybe until at least the first airing of the commercial. It is only necessary that when the commercial is received by the STB 430, the STB 430 is ready to process the information-added-to-commercial. In addition, the information-added-to-commercial may be transmitted not only once but more than once by the first airing of the commercial.

As the receiver unit 431 receives the information-added-to-commercial first as a program stream, the information-added-to-commercial is temporarily recorded in the memory means 435 within the STB 430.

The receiver unit 431 then receives the commercial. The received commercial is outputted as an AV signal to the display means 436 which will thereafter output the signal to the display unit 421 of the television set 420. The commercial is displayed in the display unit 421.

In ordinary circumstances, in the STB 430, the check means 432 refers to the information portion of the program stream and checks a channel on which and an hour at which the receiver unit 431 is receiving the program. The check at this stage is carried out with reference to the information-added-to-commercial already temporarily recorded in the memory means 435, which operation is performed while the STB 430 is working. Thus, the check means 432 takes the receiving operation of the STB 430 as watching of the program by a viewer on the television set 420.

Next, as the receiver unit 431 receives the program stream of the commercial which is associated with the information-added-to-commercial, the check means 432, referring to the information-added-to-commercial in the memory means 435, confirms that the airing time zone and the channel of the commercial match with the air time and the channel of the received commercial.

In response to the confirmation done by the check means 432, the effective term calculation means 433 detects the hour at which the commercial is currently being received (This is merely one example of a viewing hour according to the present invention and may therefore be the date and a time slot.), and calculates, as the effective term, a period which is left from the detected hour by the deadline for applying for the prize-offered campaign which is described in the information-added-to-commercial.

Acquiring the effective term from the effective term calculation means 433, the ID calculation means 434 calculates a predetermined ID based on the effective term. The ID is to serve as a proof to the digital broadcast station 410 showing the receipt of the commercial by the television set 420 at the hour above. The ID calculation means 434 may calculate the ID directly from the hour at which the commercial is received, other than calculating based on the effective term.

After the ID calculation means 434 calculates the ID, the ID is temporarily stored in the memory means 435.

The display means 436 then reads out the information-added-to-commercial from the memory means 435, creates the content of the prize-offered campaign as privilege information, superimposes this and the effective term calculated by the effective term calculation means 433 as a video signal over the commercial already received by the receiver unit 431, and outputs to the television set 420 as an AV signal.

The television set 420 displays, in the display unit 421, an image of the privilege information, the effective term and the commercial in the same picture.

To a viewer watching the television set 420, the commercial in the display unit 421 is shown together with the associated prize-offered campaign and the deadline for application.

The viewer reads the prize-offered campaign displayed together with the commercial, and using the inputting means 437, creates application information to apply for the campaign to the digital broadcast station 410 and sends the application information to the digital broadcast station 4l0. At this stage, the inputting means 437 reads out the ID temporarily stored in the memory means 435 and adds the ID to the application information.

As the application information from the STB 430 is received by the digital broadcast station 410, the inverse operation means 412 processes the ID contained in the application information, whereby the hour at which the viewer watched the commercial is identified from the ID and checked against the airing term and the airing time zone of the commercial and whether the viewer actually watched the commercial or not is confirmed.

After the confirmation of the ID, the digital broadcast station 410 carries out a process regarding a prize in a conventional manner.

According to the second preferred embodiment as in the first preferred embodiment, although viewers watch the same commercial, since the content of the privilege information which is added to the commercial is different depending on an hour at which a viewer watches the commercial, the freshness of the privilege information and hence the added value of the commercial are maintained constant.

Thus, using the program distributing system according to the first preferred embodiment, the privilege information which is added to the commercial is aired separately from the commercial and shown to a viewer as a content which is based on an hour at which the viewer watches the commercial, so that the added value of the aired program can be maintained constant regardless of the term or the timing of the airing, which is similar to the first preferred embodiment.

Further, since the information-added-to-commercial is acquired and a message of application is sent utilizing the STB in digital broadcasting, it is not necessary to display an ID on a television set and it is therefore possible to sufficiently maintain the confidentiality of the information.

(Third Preferred Embodiment)

A program distributing system according to a third preferred embodiment is the program distributing system according to the first preferred embodiment as it is modified in structure such that a sender of a commercial and a sender of information-added-to-commercial are different from each other.

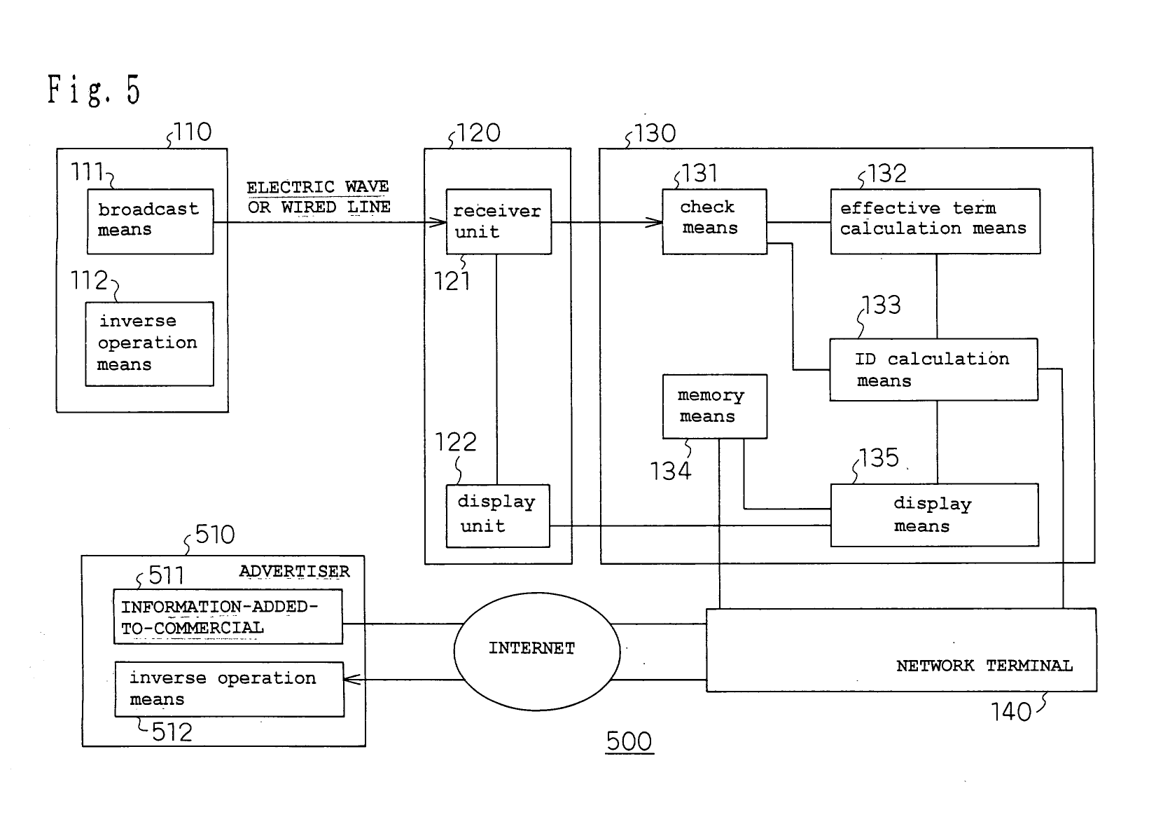

FIG. 5 is a structure diagram of the program distributing system according to the third preferred embodiment. In a program distributing system 500 shown in FIG. 5, portions which are the same as or correspond to those shown in FIGS. 1 or 3 will be denoted at the same reference symbols as those used in FIGS. 1 or 3 but will not be described in detail again. An advertiser 510 is means of communicating through the network terminal 140 and the Internet, and comprises inverse operation means 512 which has an equivalent function to that of the inverse operation means 112 according to the third preferred embodiment and information-added-to-commercial storage means 511 which stores information-added-to-commercial. It is assumed that the advertiser 510 designates an airing term, the airing start timing, the airing end timing and knows about these information in advance. In addition, the advertiser 510 is an application destination for a prize-offered campaign.

Operations of the program distributing system according to the third preferred embodiment having such a structure will now be described, in association with which operations of the first apparatus, the second apparatus and the program distributing method according to the present invention will be described. Aspects similar to those in the third preferred embodiment however will be described merely, and differences will be mainly described.

Before the broadcast station 110 broadcasts a commercial to the television set 120, the advertiser 510 sends information-added-to-commercial stored in information-added-to-commercial storage means 511 to the network terminal 140 which is connected to the Internet. Acquiring the information-added-to-commercial, the network terminal 140 transfers the information-added-to-commercial to the privilege information processing apparatus 130. The privilege information processing apparatus 130, receiving the information-added-to-commercial, stores the information-added-to-commercial in the memory means 134.

At this stage, the airing start timing for airing the information-added-to-commercial may be until at least the first airing of the commercial and it is only necessary that when the commercial is ready to be watched on the television set 120, the privilege information processing apparatus 130 is ready to process the information-added-to-commercial. In addition, the information-added-to-commercial may be transmitted not only once but more than once by the first airing of the commercial.

Subsequent operations since the broadcast station 110 broadcast the commercial until privilege information and an effective term are displayed in the display unit 122 are similar to those in the example of structure according to the first preferred embodiment shown in FIG. 3.

At last, while a viewer is writing an e-mail to apply for the prize-offered campaign using the network terminal 140, an ID is automatically inserted in the e-mail and the e-mail is sent to the advertiser 510.

Accepting the application from the viewer, the advertiser 510 processes the ID described in the application using the inverse operation means 512, identifies the hour at which the viewer watched the commercial is identified from the ID and checks the identified hour against the airing term and the airing time zone of the commercial, confirms whether the viewer actually watched the commercial or not, and processes the campaign in a conventional manner.

Thus, using the program distributing system according to the third preferred embodiment, the privilege information which is added to the commercial is aired separately from the commercial and shown to a viewer as a content which is based on an hour at which the viewer watches the commercial, so that the added value of the aired program can be maintained constant regardless of the term or the timing of the airing, which is similar to the first and the second preferred embodiments.

Further, since a third party different from a source which airs the commercial sends the information-added-to-commercial, an entity to actually broadcast a commercial can be a different structure from an entity to implement a prize-offered campaign which is linked with the commercial, and thus, it is possible to clearly define the separate roles of these entities.

While the foregoing has described that the advertiser 510 is the application destination for the network terminal 140 according to the third preferred embodiment, the application destination may be the broadcast station 110 only if the broadcast station 110 comprises inverse operation means.

(Fourth Preferred Embodiment)

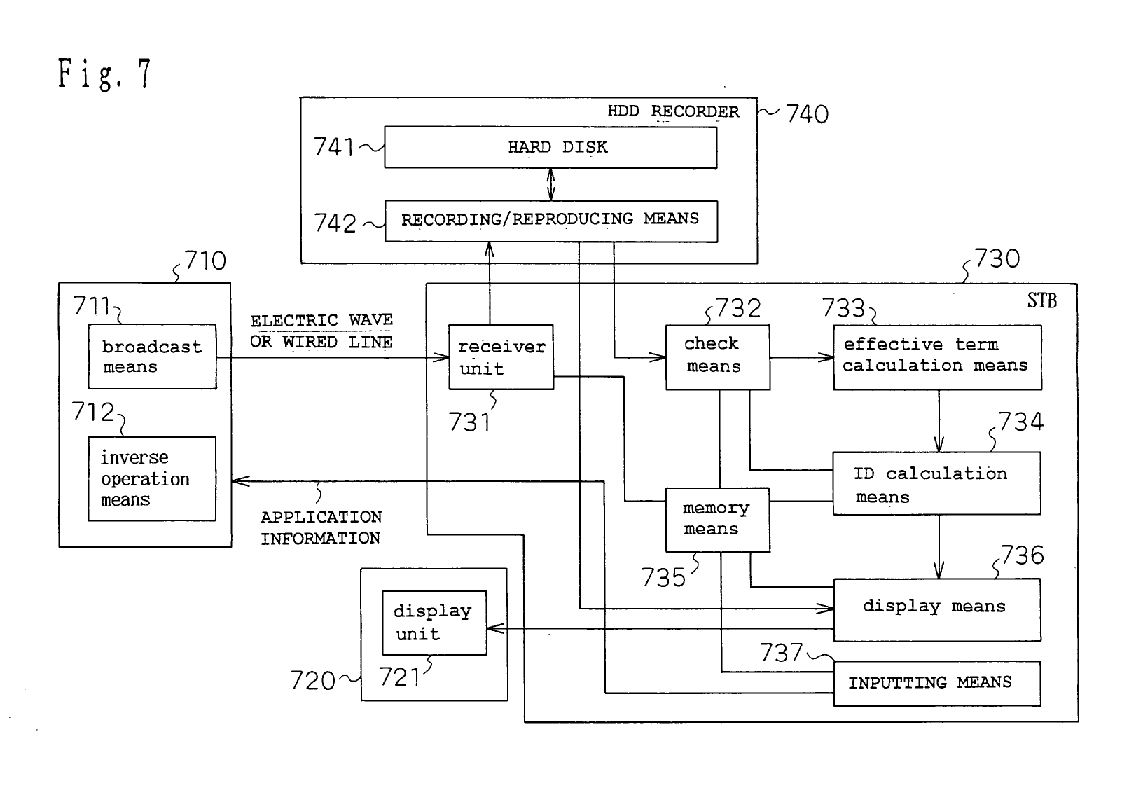

FIG. 7 is a structure diagram of a program distributing system according to a fourth preferred embodiment.

In the program distributing system according to the fourth preferred embodiment, a program added a privilege is broadcasted in digital broadcasting and temporarily recorded once aired, and a response is obtained on the basis that the time at which the program is reproduced is the time at which the program is watched.

In FIG. 7, a program distributing system 700 comprises a digital broadcast station 710 which broadcasts programs and other information, a set top box (hereinafter referred to as an “STB”) 730 to which a signal from the digital broadcast station 710 is transmitted via an electric wave, a wired line or the like, an HDD recorder 740 which records and reproduces the signal received by the STB 730, and a television set 720 which displays an AV signal which is outputted from the STB 730 or the HDD recorder 740.

The digital broadcast station 710 broadcasts a program which contains commercials and a normal content, a data broadcast program in which additional information such as character information is multiplexed, etc., in a digital broadcasting format, and comprises broadcast means 711 which broadcasts the program as a signal and inverse operation means 712 which calculates back an ID which will be described later.

The HDD recorder 740 comprises a hard disk 741 which is a recording medium and recording/reproducing means 742 which receives an AV signal representing digital airing from the STB 730, records the AV signal in the hard disk 741, reproduces the AV signal recorded on the hard disk 741 and outputs to the STB 730. The recording/reproducing means 742 can record or reproduce at any desired time under the control of a viewer.

The STB 730 is means which causes the television set 720 to display a digital broadcast, and comprises a receiver unit 731 which receives a signal from the digital broadcast station 710, check means 732 which checks the content of the broadcast outputted from the HDD recorder 740, effective term calculation means 733 which calculates an effective term based on the result of the check executed by the check means 732, ID calculation means 734 which calculates a predetermined ID based on the effective term, memory means 735 which temporarily accumulates information-added-to-commercial other than a program outputted from the HDD recorder 740 which will be described later, display means 736 which allows information read from the memory means 735 to be superimposed and displayed in a display unit 721 of the television set 720, and inputting means 737 which is disposed for bi-directional communication with the broadcast station 710 and is capable of accepting inputs from viewers.

Meanwhile, the television set 720 is means which displays the AV signal representing a broadcast which is outputted from the STB 730, and comprises the display unit 721 which displays such that the broadcast can be watched.

Operations of the program distributing system according to the fourth preferred embodiment of the present invention having such a structure will now be described, in association with which operations of the first apparatus, the second apparatus and the program distributing method according to the present invention will be described.

First, in the digital broadcast station 710, the broadcast means 711 broadcasts a commercial. The commercial is linked with a prize-offered campaign which is presented by an advertiser. Applying to an application destination described in the content of the commercial using a communication function of the STB 730, a viewer can win a prize from the advertiser. However, information itself of the prize-offered campaign is not contained in the commercial. In addition, with respect to the commercial, an airing term, the airing start timing, the airing end timing are determined in advance. In the fourth preferred embodiment, the application destination for the prize-offered campaign is the digital broadcast station 710.

Further, before airing the commercial described above, the digital broadcast station 710 broadcasts the information-added-to-commercial regarding the prize-offered campaign which is linked with the commercial. The information-added-to-commercial contains the content of and an applying period for the prize-offered campaign, and information regarding the airing term, the airing start timing, the airing end timing and a channel on which the commercial is broadcasted.

As for a method of sending the information-added-to-commercial, a multiplexed stream, i.e., a program stream of a regular program broadcast in television broadcasting to which a stream of the information-added-to-commercial is inserted, maybe sent. The airing start timing for airing the information-added-to-commercial may be until at least the first airing of the commercial. It is only necessary that when the HDD recorder 740 has started reproducing the commercial, the information-added-to-commercial is ready to be processed. In addition, the information-added-to-commercial may be transmitted not only once but more than once by the first reproduction hour of the commercial.

As the receiver unit 731 receives the information-added-to-commercial first as a program stream, the information-added-to-commercial is temporarily recorded in the memory means 735 within the STB 730.

The receiver unit 731 then receives the commercial. The received commercial is outputted as an AV signal to the HDD recorder 740.

The HDD recorder 740 records the AV signal representing the commercial on the hard disk 741.

Next, manipulating the HDD recorder 740 at desired time, a viewer reproduces the commercial which is recorded on the hard disk 741. The reproduced AV signal representing the commercial is outputted to the display means 736 which will then output the AV signal to the display unit 721 of the television set 720. The commercial is displayed in the display unit 721.

In ordinary circumstances, in the STB 730, the check means 732 checks a channel for the program reproduced by the HDD recorder 740 and the time at which the program is reproduced while referring to the information portion of the program stream. The check at this stage is carried out with reference to the information-added-to-commercial already temporarily recorded in the memory means 735, which operation is performed while the STB 730 is working. Thus, the check means 732 takes the reproduction by the HDD recorder 740 as watching of the program by a viewer on the television set 720.

Next, as the HDD recorder 740 reproduces the program stream of the commercial which is linked with the information-added-to-commercial, the check means 732 refers to the information-added-to-commercial in the memory means 735 and confirms that the channel of the commercial matches with the channel of the commercial reproduced by the HDD recorder 740 and the airing time zone of the commercial described in the information-added-to-commercial contains the hour at which the commercial is reproduced by the HDD recorder 740.

In response to the confirmation done by the check means 732, the effective term calculation means 733 detects the hour at which the commercial is currently being reproduced by the HDD recorder 740 (This is merely one example of a viewing hour according to the present invention and may therefore be the date and a time zone.), and calculates, as the effective term, a period which is left from the detected hour by the deadline for applying for the prize-offered campaign which is described in the information-added-to-commercial.

Acquiring the effective term from the effective term calculation means 733, the ID calculation means 734 calculates a predetermined ID based on the effective term. The ID is to serve as a proof to the digital broadcast station 710 showing the displaying of the commercial on the television set 720 at the hour above. The ID calculation means 734 may calculate the ID directly from the hour at which the commercial is reproduced by the HDD recorder 740, other than calculating based on the effective term.

After the ID calculation means 734 calculates the ID, the ID is temporarily stored in the memory means 735.

The display means 736 then reads out the information-added-to-commercial from the memory means 735, creates the content of the prize-offered campaign as privilege information, superimposes this and the effective term calculated by the effective term calculation means 733 as a video signal over the commercial reproduced by the HDD recorder 740, and outputs to the television set 720 as an AV signal.

Subsequent operations are similar to those of the program distributing system according to the second preferred embodiment.

According to the fourth preferred embodiment as in the second preferred embodiment, although viewers watch the same commercial, since the content of the privilege information which is added to the commercial is different depending on an hour at which a viewer watches the commercial, the freshness of the privilege information and hence the added value of the commercial are maintained constant.

Further, in the fourth preferred embodiment, since the aired commercial is recorded once in the HDD recorder 740 and the privilege information for the commercial is generated on the basis that the hour at which the commercial is reproduced is the hour at which the commercial is watched, it is possible to determine the freshness of the privilege information in accordance with the viewing hour, hence, to maintain the added value of the commercial more fairly.

Although the foregoing has described that according to the fourth preferred embodiment, a digital broadcast is temporarily recorded by the HDD recorder based on the second preferred embodiment, a VTR or other recording/reproducing apparatus which uses a recording medium such as an optical disk maybe used instead of the HDD recorder. In addition, the fourth preferred embodiment may be implemented in such a manner that an analog broadcast is temporarily recorded based on the first preferred embodiment.

(Fifth Preferred Embodiment)

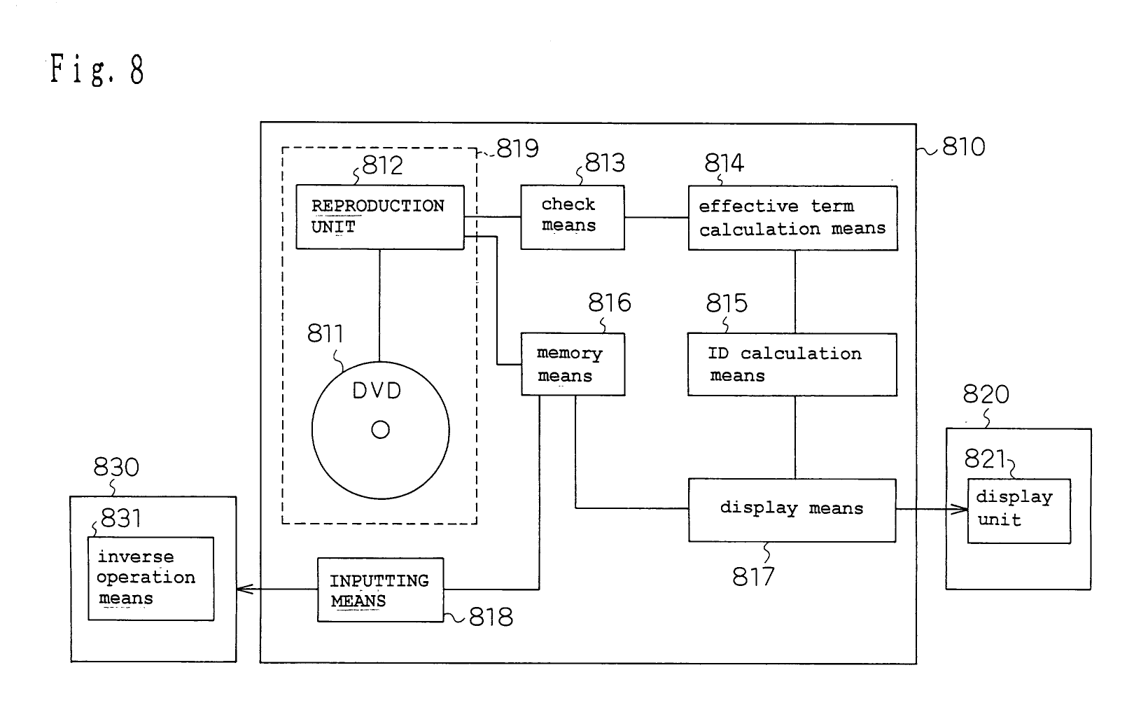

FIG. 8 is a structure diagram of a program reproducing apparatus according to a fifth preferred embodiment.

In the program reproducing apparatus according to the fifth preferred embodiment, as a content of a program which bears a privilege is temporarily recorded as the content is reproduced from a recording medium such as a DVD, and a response to the content is obtained on the basis that the time at which the content is reproduced is the hour at which the content is watched.

In FIG. 8, a program reproducing apparatus 810 comprises a reproduction block 819 including a reproduction unit 812 which plays back a DVD 811, check means 813 which checks the program content outputted from the reproduction block 819, effective term calculation means 814 which calculates an effective term based on the result of the check executed by the check means 813, ID calculation means 815 which calculates a predetermined ID based on the effective term, memory means 816 which temporarily accumulates information-added-to-commercial other than the program outputted from the reproduction block 819 which will be described later, display means 817 which allows information read from the memory means 816 to be superimposed and displayed in a display unit 821 of a television set 820, and inputting means 818 which is disposed for interactive communication with a program content provider 830 in the DVD 811 and is capable of accepting inputs from viewers.

The program content provider 830 provides the program which is recorded on the DVD 811, and comprises inverse operation means 831 which calculates back an ID which will be described later.

Meanwhile, the television set 820 is means which displays an AV signal representing the program content which is outputted from the program reproducing apparatus 810, and comprises the display unit 821 which displays such that the program content can be watched.

Operations of a program reproducing apparatus according to the fifth preferred embodiment of the present invention having such a structure will now be described, in association with which operations in the program reproducing method according to the present invention will be described.

It is assumed first that recorded as the program content which is a program stream on the DVD 811 is a normal content and a commercial which is created by the program content provider 830. The commercial is linked with a prize-offered campaign which is presented by an advertiser. Applying via an e-mail to an application destination described in a content of the commercial using the inputting means 818, a user of the program reproducing apparatus 810 can win a prize from the advertiser. However, information itself of the prize-offered campaign is not contained in the commercial. In addition, with respect to the commercial, an airing term, the airing start timing, the airing end timing are determined in advance. In the fifth preferred embodiment, the application destination for the prize-offered campaign is the program content provider 830.

Also recorded on the DVD 811 in addition to the commercial is information-added-to-commercial regarding the prize-offered campaign which is linked with the commercial. The information-added-to-commercial contains the content of and an applying period for the prize-offered campaign, and information regarding the duration of the effective term, the start of the effective term and the end of the effective term of the commercial.

The timing of reproducing the information-added-to-commercial may be until at least the first reproduction hour of the commercial. It is only necessary that the reproduction block 819 has started reproducing the commercial, the information-added-to-commercial is ready to be processed. In addition, the information-added-to-commercial may be reproduced not only once but more than once by the first reproduction hour of the commercial.

As for the DVD 811, as the DVD 811 is loaded first in the reproduction block 819 in a reproducible condition, the reproduction unit 812 automatically reproduces only the information-added-to-commercial which will be then temporarily recorded in the memory means 816. The reproduction of the information-added-to-commercial at this stage may be triggered by the loading of the DVD 811 or carried out at the time of reproduction of the program content stored on the DVD 811.

The reproduction unit 812 thereafter reproduces the normal program content from the DVD 811. The reproduced commercial is outputted as an AV signal to the display means 817 which will then output the AV signal to the display unit 821 of the television set 820. The commercial is displayed in the display unit 821.

The check means 813 checks the time at the reproduction block 819 reproduces the program content. The check at this stage is carried out with reference to the information-added-to-commercial already temporarily recorded in the memory means 816, which operation is performed while the program reproducing apparatus 810 is operating. Thus, the check means 813 takes the reproduction by the reproduction block 819 as watching of the program by a viewer on the television set 820.

Next, as the reproduction block 819 reproduces the program content of the commercial linked with the information-added-to-commercial, the check means 813 refers to the information-added-to-commercial in the memory means 816 and confirms that a reproduction time zone of the commercial described in the information-added-to-commercial contains the hour at which the commercial is reproduced by the reproduction block 819.

In response to the confirmation done by the check means 813, the effective term calculation means 814 then detects the hour at which the commercial is currently being reproduced (This is merely one example of a viewing hour according to the present invention and may therefore be the date and a time period.), and calculates, as the effective term, a period which is left from the detected hour by the deadline for applying for the prize-offered campaign which is described in the information-added-to-commercial.

Following this, the ID calculation means 815, acquiring the effective term from the effective term calculation means 814, calculates a predetermined ID based on the effective term. The ID is to serve as a proof to the program content provider 830 showing the reproduction of the commercial on the television set 820 at the hour above. The ID calculation means 815 may calculate the ID directly from the hour at which the commercial is reproduced by the reproduction block 819, other than calculating based on the effective term.

After the ID calculation means 815 calculates the ID, the ID is temporarily stored in the memory means 816.

The display means 817 then reads out the information-added-to-commercial from the memory means 816, creates the content of the prize-offered campaign as privilege information, superimposes this and the effective term calculated by the effective term calculation means 814 as a video signal over the commercial reproduced by the reproduction block 819, and outputs to the television set 820 as an AV signal.

Subsequent operations are similar to those of the program distributing system according to the second preferred embodiment.

According to the fifth preferred embodiment as in the second preferred embodiment, although viewers watch the same commercial from the DVD 811, since the content of the privilege information which is added to the commercial is different depending on the hour at which the DVD 811 is played back, i.e., an hour at which a viewer watches the commercial, the freshness of the privilege information and hence the added value of the commercial are maintained constant. While the foregoing has described that the DVD 811 is used as one example of the recording medium according to the present invention, the recording medium may be other optical disk, a magnetic optical disk or a semiconductor memory, or a magnetic recording medium such as a hard disk.

Although the foregoing has described that the destination for a viewer to sends an e-mail, a postal mail or application information to (the broadcast station 110, the digital broadcast stations 410 and 710, the advertiser 510, the program content provider 830) for application always comprises the inverse operation means 112, 512 or the like according to the respective preferred embodiments, it is not always necessary that the destination to apply or send to comprises inverse operation means. An alternative may be that after the destination to apply or send to compiles e-mails, postal mails or application information for application from the viewing public, the total is transferred to a third party organization which comprises inverse operation means so that the third party organization checks IDs. In short, the inverse operation means may be a separate structure.

Alternatively, the inverse operation means may be omitted from the overall system, to thereby realize a program distributing method omitting ID check.

Further, the display means 135, 436 and 736 may omit ID check and display only the effective term and the information regarding the privilege instead or the information regarding the privilege alone instead.

In the description above, the privilege information processing apparatus 130 and the STBs 430 and 730 are examples of the first apparatus according to the present invention, while the broadcast station 110 and the digital broadcast stations 410 and 710 are examples of the second apparatus according to the present invention. Further, a commercial is one example of the particular program which provides a privilege according to the present invention, the information-added-to-commercial and the privilege information are examples of information regarding a privilege according to the present invention, the information-added-to-commercial is one example of information regarding a channel on which and an hour at which the particular program which provides a privilege is broadcasted according to the present invention, the hour at which a commercial is currently being received which is processed by the effective term calculation means is one example of the viewing time according to the present invention.

The structure according to the present invention is not limited to the preferred embodiments above. The second apparatus according to the present invention may be realized over both the broadcast station 110 and the privilege information processing apparatus 130. In other words, the structure may be that the broadcast station 110 partially serves as the second apparatus according to the present invention and accordingly comprises the check means, the effective term calculation means and ID calculation means while the privilege information processing apparatus 130 comprises only the display means of the second apparatus according to the present invention.

The second apparatus according to the present invention may be incorporated in an apparatus which can receive the privilege-bearing particular program and may be accordingly manipulated. Examples of such an apparatus a television, are a personal computer, a portable information terminal and the like which can be connected to the Internet.

The particular program which provides a privilege according to the present invention is not limited to a commercial but may be a program such as a movie and a drama. The privilege information is not limited to a video signal but may be displayed as speech information, character information, etc.

Privileges are not limited to a prize but may be commercial products, presents, services, refund, offering of points having commercial values, etc.

The viewing time according to the present invention is not limited to an hour but may be a unit of time such as a day, a plurality of days, a zone within a particular range and a week.

Further, the present invention is directed to a program which works with a computer and makes the computer perform the functions of all or some of the means (or apparatuses, elements, circuits, units, etc.) of the program distributing system, the second apparatus and the program reproducing apparatus according to the present invention described above.

Further, the present invention is also directed to a medium which holds a program for making a computer perform the functions of all or some of the means of the program distributing system, the second apparatus and the program reproducing apparatus according to the present invention described above, which can be read on the computer so that the program thus read works with the computer and executes these functions.

Some of the means (or apparatuses, elements, circuits, units, etc.) according to the present invention refer to a few means of these means or at these steps, or refer to a part of the functions of one means.

Some apparatuses (or elements, circuits, units, etc.) according to the present invention refer to a few apparatuses of the plurality of apparatuses, or refer to some of the means (or elements, circuits, units, etc.) disposed in one apparatus, or refer to a part of the functions of one means.

Also contained in the present invention is a recording medium in which the program according to the present invention is recorded and which can be read on a computer.

As one example of use, the program according to the present invention may be recorded on a recording medium which can be read on a computer and works together with the computer.

As other example of use, the program according to the present invention may be transmitted through a transmission medium, read on a computer and works together with the computer.

Such a computer used in the present invention is not limited to pure hardware such as a CPU or may include firmware, OS or further peripheral equipment.

The recording medium may be a ROM or the like, while the transmission medium may be a transmission mechanism, such as an optical fiber and the Internet, or light, an electric wave, a sound wave, etc.

As described above, the structure according to the present invention may be realized with software or hardware.

As described above, the present invention provides a program distributing system or the like with which it is possible to maintain the added value of a program equally to viewers who watch the same program at different hours.

What is claimed is:

1. A program distributing system, comprising:
a first apparatus which comprises broadcast means which broadcasts a particular program which provides a privilege; and
a second apparatus which comprises:
check means which executes a check to find whether said particular program is watched or not from a channel on which and a time zone in which a program is being currently received;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

2. A program distributing system, comprising:
a first apparatus which comprises broadcast means which broadcasts a particular program which provides a privilege; and
a second apparatus which comprises:
check means which executes a check to find whether said particular program is watched or not by detecting reproduction of said program after storage of said program in a recording medium;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

3. The program distributing system of claim 1 or 2, wherein said ID is obtained by executing predetermined computation on said ID and calculating back said viewing time or said effective term.

4. A program reproducing apparatus, comprising:
check means which executes a check to find whether a particular program which provides a privilege is watched or not by detecting playback of a recording medium in which said particular program is recorded;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

5. The program reproducing apparatus of claim 4, wherein said ID is obtained by executing predetermined computation on said ID and calculating back said viewing time or said effective term.

6. A first apparatus which comprises broadcast means which broadcasts a particular program which is received by a second apparatus and provides a privilege, wherein said second apparatus comprises:
check means which executes a check to find whether said particular program is watched or not from a channel on which and a time zone in which a program is being currently received;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

7. A first apparatus which comprises broadcast means which broadcasts a particular program which is received by a second apparatus and provides a privilege, wherein said second apparatus comprises:
check means which executes a check to find whether said particular program is watched or not by detecting reproduction of said program after storage of said program in a recording medium;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

8. The first apparatus of claim 6 or 7, wherein said ID is obtained by executing predetermined computation on said ID and calculating back said viewing time or said effective term.

9. The first apparatus of claim 6 or 7, wherein said broadcast means also broadcasts information regarding said privilege and information regarding a channel on which and an hour at which said particular program which provides said privilege is broadcasted.

10. The first apparatus of claim 9, wherein broadcasting of the information regarding said privilege and the information regarding a channel on which and an hour at which said particular program which provides said privilege is broadcasted takes place before the first airdate/airtime for said particular program which provides said privilege.

11. The program reproducing apparatus of claim 4, wherein said recording medium is recorded information regarding said privilege and information regarding the time at which said particular program is to be reproduced.

12. The program reproducing apparatus of claim 4, wherein said display means is capable of causing said ID as well to be displayed.

13. A second apparatus which receives a particular program provides a privilege and which is broadcasted from a first apparatus which comprises broadcast means which broadcasts said particular program, comprising:
check means which executes a check to find whether said particular program is watched or not from a channel on which and a time zone in which a program is being currently received;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

14. A second apparatus which receives a particular program provides a privilege and which is broadcasted from a first apparatus which comprises broadcast means which broadcasts said particular program, comprising:
check means which executes a check to find whether said particular program is watched or not by detecting reproduction of said program after storage of said program in a recording medium;
effective term calculation means which calculates the effective term for said privilege from the viewing time of said particular program when it is determined as a result of said check that said particular program is watched;
ID calculation means which calculates an ID based on said viewing time or said effective term; and
display means which causes at least information regarding said privilege to be displayed.

15. The second apparatus of claim 13 or 14, wherein said ID is obtained by executing predetermined computation on said ID and calculating back said viewing time or said effective term.

16. The second apparatus of claim 13 or 14, wherein said broadcast means of said first apparatus also broadcasts information regarding said privilege and information regarding a channel in which and an hour at which said particular program which provides said privilege is broadcasted.

17. The second apparatus of claim 16, wherein broadcasting of the information regarding said privilege and the information regarding the channel on which and the time at which said particular program which provides said privilege is broadcasted takes place before the first airdate/airtime of said particular program which provides said privilege.

18. The second apparatus of claim 13 or 14, wherein said display means is capable of causing said ID as well to be displayed.

19. A program distributing method, comprising:
a broadcast step of broadcasting a particular program which provides a privilege;
a check step of checking whether said particular program is watched or not from a channel on which and a time zone in which a program is being currently received;
an effective term calculation step of calculating the effective term for said privilege from the viewing time of said particular program when it is determined as a result of said check that said particular program is watched;
an ID calculation step of calculating an ID based on said viewing time or said effective term; and
a display step of causing at least information regarding said privilege to be displayed.

20. A program distributing method, comprising:
a broadcast step of broadcasting a particular program which provides a privilege;
a check step of executing a check to find whether said particular program is watched or not by detecting reproduction of said program after storage of said program in a recording medium;
an effective term calculation step of calculating the effective term for said privilege from the viewing time of said particular program when it is determined as a result of said check that said particular program is watched;
an ID calculation step of calculating an ID based on said viewing time or said effective term; and
a display step of causing at least information regarding said privilege to be displayed.

21. A program reproducing method, comprising:
a check step of executing a check to find whether a particular program which provides a privilege is watched or not by detecting playback of a recording medium in which said particular program is recorded;
an effective term calculation step of calculating the effective term for said privilege from the viewing time of said particular program when it is determined as a result of said check that said particular program is watched;
an ID calculation step of calculating an ID based on said viewing time or said effective term; and
a display step of causing at least information regarding said privilege to be displayed.

22. The program reproducing method of claim 19 or 20, wherein said ID is obtained by executing predetermined computation on said ID and calculating back said viewing time or said effective term.

23. The program reproducing method of claim 21, wherein said ID is obtained by executing predetermined computation on said ID and calculating back said viewing time or said effective term.

24. A program which makes a computer function as all or some of said broadcast means of said first apparatus which broadcasts a particular program which provides a privilege, and said check means of said second apparatus which executes a check to find whether said particular program is watched or not from a channel on which and a time zone in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term and said display means of said second apparatus which causes at least information regarding said privilege to be displayed of the program distributing system of claim 1.

25. A program which makes a computer function as all or some of said broadcast means of said first apparatus which broadcasts a particular program which provides a privilege, and said check means of said second apparatus which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term and said display means of said second apparatus which causes at least information regarding said privilege to be displayed of the program distributing system of claim 2.

26. A program which makes a computer function as all or some of said check means which executes a check to find whether a particular program which provides a privilege is watched or not by detecting playback of a recording medium in which said particular program is recorded, said effective term calculation means of said program reproducing apparatus which calculates the effective term for said privilege from the viewing time of said particular program when it is determined as a result of said check that said particular program is watched, and said ID calculation means of said program reproducing apparatus which calculates an ID based on said viewing time or said effective term, and said display means of said second apparatus which causes at least information regarding said privilege to be displayed of the program reproducing apparatus of claim 4.

27. A program which makes a computer function as all or some of said check means which executes a check to find whether said particular program is watched or not from a channel on which and a slot in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of claim 13.

28. A program which makes a computer function as all or some of said check means which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of claim 14.

29. A medium which can be processed on a computer and holds a program which makes a computer function as all or some of said broadcast means of said first apparatus which broadcasts a particular program which provides a privilege, and said check means of said second apparatus which executes a check to find whether said particular program is watched or not from a channel on which and a time zone in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the program distributing system of claim 1.

30. A medium which can be processed on a computer and holds a program which makes a computer function as all or some of said broadcast means of said first apparatus which broadcasts a particular program which provides a privilege, and said check means of said second apparatus which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the program distributing system of claim 2.

31. A medium which can be processed on a computer and holds a program which makes a computer function as all or some of said check means which executes a check to find whether a particular program which provides a privilege is watched or not by detecting playback of a recording medium in which said particular program is recorded, said effective term calculation means of said program reproducing apparatus which calculates the effective term for said privilege from the viewing time of said particular program when it is determined as a result of said check that said particular program is watched, and said ID calculation means of said program reproducing apparatus which calculates an ID based on said viewing time or said effective term, and said display means of said second apparatus which causes at least information regarding said privilege to be displayed of the program reproducing apparatus of claim 4.

32. A medium which can be processed on a computer and holds a program which makes a computer function as all or some of said check means which executes a check to find whether said particular program is watched or not from a channel on which and a slot in which a program is being currently received, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of claim 13.

33. A medium which can be processed on a computer and holds a program which makes a computer function as all or some of said check means which executes a check to find whether said particular program is watched or not by detecting reproduction of said program after storage of said program in a recording medium, said effective term calculation means of said second apparatus which calculates the effective term for said privilege from the viewing time of said particular program when it is determined as a result of said check that said particular program is watched, said ID calculation means of said second apparatus which calculates an ID based on said viewing time or said effective term, and said display means of said second apparatus which causes at least information regarding said privilege to be displayed of the second apparatus of claim 14.
